(19) United States
(12) Patent Application Publication
(10) Pub. No.: US 2006/0051002 A1
(43) Pub. Date: Mar. 9, 2006

(54) Fluid Dynamic Pressure Bearing, Spindle Motor Provided with Fluid Dynamic Pressure Bearing, and Recording Disk Drive Device Provided with Spindle Motor

(75) Inventors: Yoichi Sekii, Kyoto (JP); Takehito Tamaoka, Kyoto (JP)

Correspondence Address: JUDGE PATENT FIRM;RIVIERE SHUKUGAWA 3RD FL., 3-1 WAKAMATSU-CHO, NISHINOMIYA-SHI, HYOGO, 662-0035, JP

(73) Assignee: NIDEC CORPORATION, Kyoto (JP)

(21) Appl. No.: 11/162,359

(22) Filed: Sep. 8, 2005

(30) Foreign Application Priority Data
Sep. 8, 2004 (JP) 2004-261239

(51) Int. Cl. F16C 32/06

(52) U.S. Cl. 384/107

(57) ABSTRACT

In a fluid dynamic pressure bearing, a capillary seal (32) is configured in a third fine clearance (11) defined between an upper peripheral surface of a bearing housing (4) and an inner circumferential surface of an annular member (30) fixed onto a rotor upper wall (16a). Furthermore, the annular member (30) is formed by press working.

### BACKGROUND OF THE INVENTION

1. Field of the Invention

The invention relates to a fluid dynamic pressure bearing, a spindle motor provided with the fluid dynamic pressure bearing, and a recording disk drive device provided with the spindle motor.

2. Background Art

A fluid dynamic pressure bearing, which utilizes a dynamic pressure generated in a lubricating fluid such as oil to be retained in a clearance defined between a shaft and a sleeve during rotation of a motor, has been conventionally used as a bearing in the motor for rotating a recording disk in a hard disk drive device, a removable disk drive device or the like. Various kinds of such fluid dynamic pressure bearings have been proposed heretofore.

As shown in FIG. 9, a motor in the prior art includes a pair of radial bearings 106 arranged separately in an axial direction at a clearance defined between an outer peripheral surface of a shaft 102 and an inner circumferential surface of a sleeve 104. Furthermore, upper and lower thrust bearings 112 and 113 are formed at clearances defined between an upper end surface of a thrust plate 108 fixed integrally with the shaft 102 and a lower surface of the sleeve 104 axially facing to the thrust plate 108 and between a lower end surfaces of the thrust plate 108 and an upper surface of a counter plate 110, respectively.

Moreover, the motor in the prior art includes a capillary seal 11 8 formed between a fitting portion 116, at which the shaft 102 is fitted into a rotor hub 114 fixed to the upper portion of the shaft 102, and the radial bearing 106 by gradually reducing the diameter of the shaft 102 at the upper peripheral surface thereof upward in the axial direction.

The capillary seal 118 is adapted to produce a difference in capillary force according to a position, at which a gas-liquid interface of the oil to be retained inside of the capillary seal 118 is formed. In the case where the oil retained in each of the radial bearing 106 and the upper and lower thrust bearings 112 and 113 is decreased in quantity, the oil is supplied from the capillary seal 118 to the radial bearing 106 and the upper and lower thrust bearings 112 and 113. In addition, in the case where the oil retained in each of the radial bearing 106 and the upper and lower thrust bearings 112 and 113 is increased in volume caused by an increase in temperature at a spindle motor in association with the rotation of the motor, the capillary seal 118 is designed to contain therein the oil by the increased volume.

In this manner, the oil is sequentially retained without intermission in the fine clearances defined in the radial bearing 106, the upper and lower thrust bearings 112 and 113 and the capillary seal 118 (such an oil retaining structure will be hereinafter referred to as “a full-fill structure”). Upon the rotation of the motor, the dynamic pressure is generated in the radial bearing 106 and the upper and lower thrust bearings 112 and 113, so that the sleeve 104 rotatably supports the shaft 102 and the rotor hub 114 in a non-contact manner.

In recent years, a recording disk drive device for use in equipment such as a personal computer has been started to be applied to a portable information terminal which is more miniaturized. A smaller size, a more reduced thickness and lower power consumption have been desired for the spindle motor in addition to the high-speed and highly accurate rotation heretofore.

However, in the case where the spindle motor is intended to be reduced in size and thickness, it has been difficult to reduce the spindle motor in size and thickness since the fitting portion 116, the capillary seal 118, the pair of radial bearings 106 and the upper and lower thrust bearings 112 and 113 are arranged in parallel to each other in the axial direction in the above-described configuration.

In other words, if the bearing stiffness of each of the pair of radial bearings 106 is intended to be secured in accordance with the demand for the reduction of the size and the thickness of the spindle motor, it has become difficult to secure the axial dimension of the fitting portion 116 and the upper and lower thrust bearings 112 and 113. If the axial dimension of the fitting portion 116 becomes shorter, the tightening strength between the shaft 102 and the rotor hub 114 has become weaker. Consequently, since the parallelism of the rotor hub 114 during the rotation of the motor has been lost, the rotor hub 114 has been loosened, thereby obstructing a stable rotation from being achieved.

In contrast, if the axial dimension of the fitting portion 116 is intended to be secured, the axial dimension of each of the pair of radial bearings 106 has become shorter, and further, the bearing stiffness has become weaker, thereby obstructing the shaft from being stably supported. The rotational accuracy or attitude maintenance of the shaft 102 and the rotor hub 114 has depended exclusively upon the pair of radial bearings 106, and therefore, it has been necessary to sufficiently take an axial clearance defined between the pair of radial bearings 106. As a consequence, it has been very difficult to reduce the spindle motor in size and thickness while maintaining the required rotational accuracy in the above-described motor.

Additionally, if the axial dimension of each of the pair of radial bearings 106 and the fitting portion 116 is intended to be secured, it has been difficult to secure the bearing stiffness of each of the upper and lower thrust bearings 112 and 113. The thrust plate 108 has been fixed to the lower portion of the shaft 102 in the above-described motor, and an axial movement of each of the shaft 102 and the rotor hub 114 can be restricted by an axial load supporting force generated at each of the upper and lower thrust bearings 112 and 113 formed at the upper and lower end surfaces of the thrust plate 108, thereby stabilizing the floating of the shaft 102 and the rotor hub 114.

However, if the axial dimension of the thrust plate 108 is reduced in order to thin the upper and lower thrust bearings 112 and 113, a stable axial load supporting force cannot be achieved at the upper and lower thrust bearings 112 and 113, and therefore, the bearing stiffness of the upper and lower thrust bearings 112 and 113 has been degraded. Consequently, the shaft 102 and the rotor hub 114 have been excessively floated, thereby making it difficult to stably support the shaft 102 and the rotor hub 114.

Furthermore, a recording disk drive device has been recently started to be mounted on vehicle-installed equipment represented by a car navigation system. However, the recording disk drive device is assumed to be used in various kinds of ambiences in the case of the vehicle-installed equipment, so that the recording disk drive device has been requested to be stably operated within a very wide temperature range. For example, the recording disk drive device has been requested to be operated in a severest temperature ambience which has not been considered so far: for example, the recording disk drive device can be used in an ambience in which a difference in temperature is 100° C. or higher.

The viscosity of oil has been decreased in a high temperature ambience, and accordingly, a dynamic pressure generated also has been decreased. As a result, it has been difficult to achieve a predetermined bearing stiffness. If oil having a high viscosity is used in order to avoid such a decrease in viscosity of the oil, the viscosity has become excessively high in a low temperature ambience, so that a rotational load of the motor is increased, thereby increasing an electric consumption by the motor. In view of this, it has been necessary to solve mutually contradictory problems that the degradation of the bearing stiffness in the high temperature ambience is prevented while the increase in electric consumption by the motor is suppressed in the low temperature ambience such that the motor using a fluid dynamic pressure bearing can be applied within a wide temperature range.

The viscosity of the oil has been decreased and the volume of the oil has been increased due to thermal expansion in the high temperature ambience. As a consequence, the oil retained in each of the fluid dynamic pressure bearings has been pushed toward the capillary seal 118 from each of the fluid dynamic pressure bearings by the increased volume. At this time, in the case where the axial dimension of the capillary seal 118 is limited, and therefore, where its capacity cannot be satisfactorily secured with the dimensional limitation of the small size and thinness of the motor, all of the oil flowing into the capillary seal 118 may not be sufficiently contained, and as a result, the oil may flow outward of the capillary seal 118. In this case, the flowing-out oil may adhere to a hard disk on a side of the drive device or a magnetic head disposed near the hard disk, thereby causing a reading/writing error.

To the contrary, if the axial dimension of the capillary seal 118 is satisfactorily secured so as to retain the oil by the above-described increased volume, the axial dimension of each of the pair of radial bearings 106 axially arranged in parallel to the capillary seal 118 has been restricted, thereby making it difficult to secure the bearing stiffness of the radial bearing 106. In addition, it has become difficult to secure the axial dimension of the fitting portion 116 between the shaft 102 and the rotary hub 114 axially arranged in parallel to the capillary seal 118 in the same manner.

### BRIEF SUMMARY OF THE INVENTION

According to the present invention, it is possible to secure the bearing stiffness of each of a radial dynamic pressure bearing and a thrust dynamic pressure bearing and the axial dimension of a capillary seal, and further, reduce in size and thickness of a motor as a whole.

Furthermore, it is possible to reduce a cost of each of a fluid dynamic pressure bearing, a spindle motor and a recording disk drive device.

Moreover, it is possible to secure a stable bearing stiffness and prevent oil from flowing outward of a motor in a high temperature ambience so as to enhance reliability and durability without any increase in electric consumption of the motor irrespective of variations in usage ambience.

A fluid dynamic pressure bearing according to one aspect of the invention comprises: a rotor unit rotated coaxially with a rotational center axis and including a shaft, a rotor hub and an annular member; and a stationary unit including a bearing member.

The rotor hub has a rotor upper wall fixed to an upper end of the shaft, and the annular member is a substantially conical pressed member, which is fixed to a lower surface of the rotor upper wall and extends downward in an axial direction. The bearing member has an inner circumferential surface facing to an outer peripheral surface of the shaft via a first fine clearance, an upper end surface facing to the lower surface of the rotor upper wall via a second fine clearance, and an outer peripheral surface facing to an inner circumferential surface of the annular member via a third fine clearance.

Furthermore, the first, second and third fine clearances are filled with lubricating fluid substantially without interruption. The third fine clearance has a capillary seal whose radial clearance width is gradually enlarged downward in the axial direction, and further, the lubricating fluid retained in the third fine clearance defines an interface between air and the same inside of the capillary seal.

In the fluid dynamic pressure bearing according to one aspect of the invention, the annular member is formed by press working, thereby reducing a fabrication cost. Furthermore, the motor as a whole can be reduced in thickness and size by forming the capillary seal outward in the radial direction of the bearing member in comparison with a structure in which a capillary seal is formed on substantially the same line as a rotational center axis, and further, the axial dimension and capacity of the capillary seal can be satisfactorily secured.

### BRIEF DESCRIPTION OF THE SEVERAL VIEWS OF THE DRAWINGS

FIG. 1 is a cross-sectional view showing a spindle motor in a first preferred embodiment according to the invention;

FIG. 2 is a longitudinally cross-sectional view showing a bearing member and a top view showing an upper end of FIG. 1;

FIG. 3 is an enlarged cross-sectional view showing essential parts in the first preferred embodiment according to the invention;

FIG. 4 is a cross-sectional view showing a welding process in the first preferred embodiment according to the invention;

FIG. 5 is an enlarged cross-sectional view showing essential parts in a second preferred embodiment according to the invention;

FIG. 6 is a cross-sectional view showing a third preferred embodiment according to the invention;

FIG. 7 is a cross-sectional view showing a fourth preferred embodiment according to the invention;

FIG. 8 is a cross-sectional view showing a recording disk drive device according to the invention; and

FIG. 9 is a cross-sectional view showing a spindle motor in the prior art.

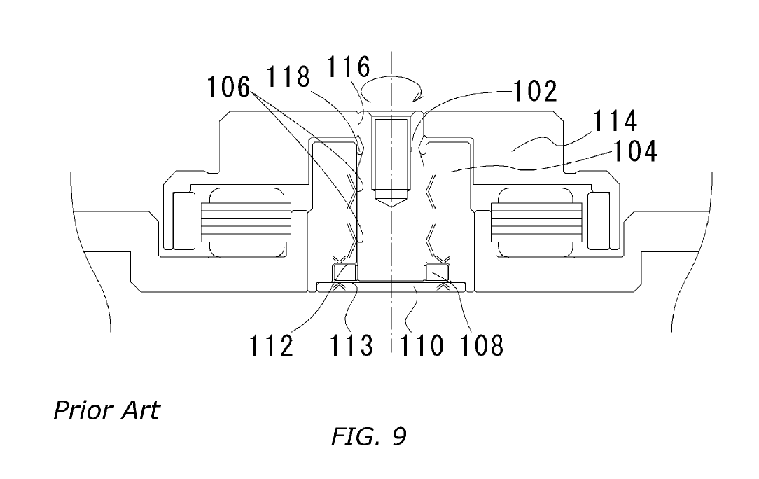

### DETAILED DESCRIPTION OF THE INVENTION

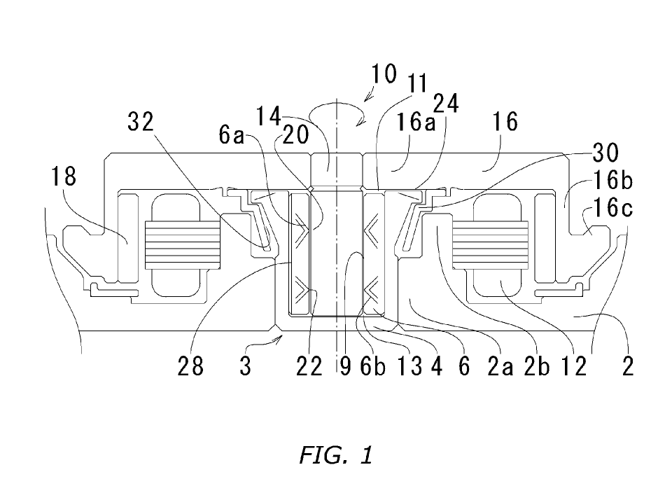

A description will be given below of a fluid dynamic pressure bearing, a spindle motor and a recording disk drive device in each of preferred embodiments according to the invention in reference to FIGS. 1 to 8. Incidentally, when a positional relationship between members or a direction is explained in reference to terms of up, down, right and left in the description below, the positional relationship or direction in the drawings is expressed, but the positional relationship or direction when the members are actually assembled in equipment is not expressed.

### First Embodiment

Structure of Spindle Motor

FIG. 1 is a cross-sectional view showing a spindle motor in a first preferred embodiment according to the invention. As shown in FIG. 1, the spindle motor in the present preferred embodiment basically includes a bracket 2, a bearing member 3 fixed to the bracket 2 and a rotor 10 rotatably supported by the bearing member 3.

An annular boss 2a is disposed around a center hole, which holds the bearing member 3 therein, at the center of the bracket 2. A cylindrical portion 2b is formed at the boss 2a. A stator 12 is held at the outer periphery of the cylindrical portion 2b by press-fitting and/or bonding, and further, the bearing member 3 is held at the inner circumference thereof by press-fitting and/or bonding.

The bearing member 3 includes a bearing housing 4 and a sleeve 6 held at the inner circumference of the bearing housing 4. The bearing housing 4 is a bottomed cylindrical member opened at the upper portion thereof and is formed by press working. At the inner circumferential surface of the bearing housing 4 is held, at the center, the cylindrical sleeve 6 having a bearing hole penetrating in an axial direction by means of an adhesive or the like. The sleeve 6 is molded of a porous material impregnated with oil as a lubricating fluid. The porous material is not particularly limited, and therefore, a material obtained by molding or sintering various kinds of metallic powder, metallic compound powder or non-metallic powder is used. Raw materials include Fe—Cu, Cu—Sn, Cu—Sn—Pb, Fe—C and the like. Incidentally, the material of the bearing housing 4 or the sleeve 6 is not limited to the above-described materials, and therefore, the bearing housing 4 or the sleeve 6 may be formed of, for example, copper, a copper alloy, stainless steel, aluminum, an aluminum alloy, a resin or the like.

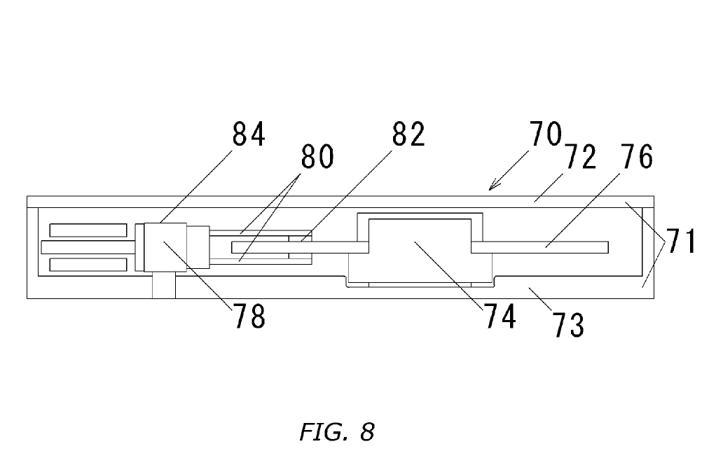

The rotor 10 includes a shaft 14 facing to the inner circumferential surface of the sleeve 6 via a clearance in a radial direction and a substantially cup-like rotor hub 16 disposed at the upper end of the shaft 14. The rotor hub 16 is provided with a rotor upper wall 16a facing to the upper end surfaces of the bearing housing 4 and the sleeve 6 in an axial direction, a rotor circumferential wall 16b suspended from the outer periphery of the rotor upper wall 16a in the axial direction, and a flange 16c located under the rotor circumferential wall 16b and extending outward of the outer peripheral surface of the rotor circumferential wall 16b in the radial direction. At the outer peripheral surface of the rotor circumferential wall 16b and the flange 16c is mounted a hard disk (designated by reference numeral 76 in FIG. 8) in contrast, at the inner circumferential surface of the rotor circumferential wall 16b is held a rotor magnet 18 via an adhesive or the like. A material of the rotor hub 16 is not particularly limited. For example, the rotor hub 16 can be formed of copper, a copper alloy, stainless steel, aluminum, an aluminum alloy or the like.

With the above-described configuration, there are continued a first fine clearance 9 defined between the outer peripheral surface of the shaft 14 and the inner circumferential surface of the sleeve 6, a second fine clearance 11 defined between the lower surface of the rotor upper wall 16a of the rotor hub 16 and the upper end surfaces of the bearing housing 4 and the sleeve 6, and a fine clearance 13 defined between the lower end surface of the sleeve 6 and the lower end surface of the shaft 14, and the bottom surface of the bearing housing 4. At the continued fine clearances 9, 11 and 13 is retained the oil without any intermission, thereby configuring a full-fill structure. Here, a clearance width of each of the first and second fine clearances 9 and 11 should be preferably less than 50 μm, and more particularly, the clearance width of the first fine clearance 9 should be preferably less than 10 μm.

Bearing Structure

At the first fine clearance 9 defined between the inner circumferential surface of the sleeve 6 and the outer peripheral surface of the shaft 14 are disposed an upper radial dynamic pressure bearing 20 and a lower radial dynamic pressure bearing 22 in separation from each other in the axial direction. The upper radial dynamic pressure bearing 20 and the lower radial dynamic pressure bearing 22 include the inner circumferential surface of the sleeve 6, the outer peripheral surface of the shaft 14 and the oil retained between both of the members facing to each other in the radial direction.

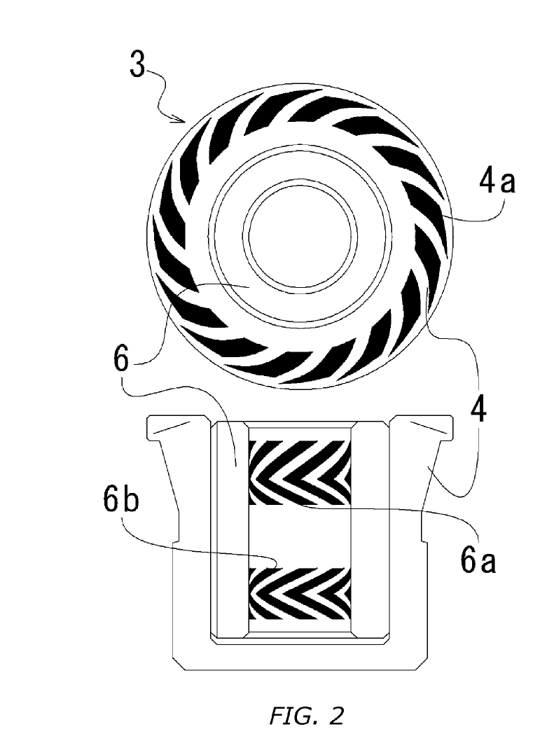

As shown in FIG. 2, herringbone grooves 6a and 6b formed into substantially a V shape, as viewed in cross section, which are inclined in directions opposite to each other and are constituted by connecting a pair of spiral grooves, are formed at portions constituting the upper and lower radial dynamic pressure bearings 20 and 22, respectively. When the rotor 10 is rotated, a pressure toward substantially the center from both of axial ends of the upper and lower radial dynamic pressure bearings 20 and 22 is induced in the oil. The oil flowing toward the center of each of the upper and lower radial dynamic pressure bearings 20 and 22 has a maximum pressure substantially at the center of each of the bearings 20 and 22, thereby supporting the rotor 10.

At the second fine clearance 11 defined between the upper end surface of the bearing member 3 and the lower surface of the rotor upper wall 16a of the rotor hub 16 is disposed a thrust dynamic pressure bearing 24. The thrust dynamic pressure bearing 24 includes the upper end surface of the bearing housing 4, the upper end surface of the sleeve 6, the lower surface of the rotor upper wall 16a of the rotor hub 16 and the oil retained in the second fine clearance 11. As shown in FIG. 2, at the upper surface of the bearing housing 4 is formed a spiral groove 4a formed into a pump-in shape. Consequently, the spiral groove 4a induces a pressure inward in the radial direction in the thrust dynamic pressure bearing 24 during the motor rotation. The pressure becomes maximum at the center of the spiral groove 4a, that is, in the vicinity of the outer peripheral surface above the shaft 14. In addition, the pressure increases the inner pressure of the oil, thereby generating a fluid dynamic pressure which acts in such a manner that the rotor 10 floats upward in the axial direction.

In this manner, the thrust dynamic pressure bearing 24 is disposed outward of the upper and lower radial dynamic pressure bearings 20 and 22 in the radial direction, so that the upper and lower radial dynamic pressure bearings 20 and 22 can be disposed within a limited dimension. As a consequence, it is possible to provide the spindle motor of a thin type having a sufficient shaft holding force. Moreover, it is possible to reduce the number of constituting bearings, reduce the viscous resistance of the oil retained in the bearing and enhance the electric efficiency of the motor by disposing only one thrust dynamic pressure bearing 24 between the upper end surface of the bearing housing 4 and the lower surface of the upper wall 16a of the rotor hub 16.

Configuration of Capillary Seal 32 and Annular Member 30

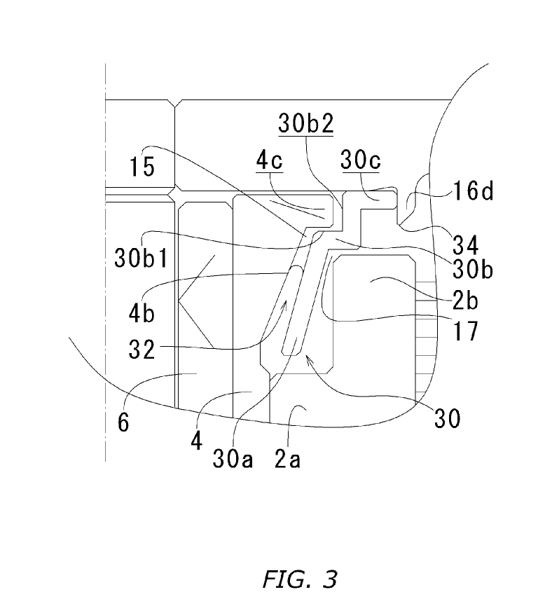

As shown in FIG. 3, at the upper outer peripheral surface of the bearing housing 4 are formed an inclined surface 4b inclined toward the rotational center axis from the upper end surface of the bearing housing 4 and a flange 4c interposed between the inclined surface 4b and the upper end surface of the bearing housing 4 and extending from the inclined surface 4b in the radial direction.

At the lower surface of the rotor upper wall 16a of the rotor hub 16 is formed a projection 16d disposed outward of the bearing housing 4 in the radial direction and projecting toward the bracket 2. To the inner circumference of the projection 16d is fixed an annular member 30, which is formed into a substantially conical shape and is formed by press working to a disk member.

The annular member 30 includes a columnar portion 30a, which has an inner circumferential surface radially facing to the outer peripheral surface of the inclined surface 4b of the bearing housing 4, a engaging portion 30b, which is formed into a substantial L shape and is disposed upward of the columnar portion 30a in the axial direction in continuous contact with the columnar portion 30a, and a connecting portion 30c, which is positioned above the engaging portion 30b in continuous contact with the engaging portion 30b and is fixed to the rotor upper wall 16a.

The width of a third fine clearance 15 defined between the inner circumferential surface of the annular member 30 and the outer peripheral surface of the bearing housing 4 is gradually enlarged from the lower surface of the rotor upper wall 16a toward the rotational center axis: namely, a capillary seal 32 is constituted in cooperation of the outer peripheral surface of the bearing housing 4 with the inner circumferential surface of the columnar portion 30a of the annular member 30. The oil retained in each of the above-described dynamic pressure bearings is balanced in surface tension and outside atmosphere only at the capillary seal 32, so that an interface between the oil and air is formed into a meniscus shape.

Incidentally, in the present preferred embodiment, the inclination angle of the inclined surface 4b of the bearing housing 4 should be preferably set within a range from about 2° to about 30° with respect to the rotational center axis, and more preferably, within a range from about 10° to about 20°: in contrast, the inclination angle of the inner circumferential surface of the columnar portion 30a of the annular member 30 should be preferably set within a range from about 0° to about 20° with respect to the rotational center axis, and more preferably, within a range from about 5° to about 15°.

As described above, since the inclination angle of the inclined surface 4b of the bearing housing 4 and the inclination angle of the inner circumferential surface of the columnar portion 30a of the annular member 30 are different from each other with respect to the rotational center axis, the capillary seal 32 also is inclined inward in the radial direction.

Consequently, the interface of the oil defined at the capillary seal 32 also is oriented inward in the radial direction according to the inclination angle of the capillary seal 32 with respect to the rotational center axis. Therefore, the interface of the oil is pressed toward the rotor upper wall 16a by a centrifugal force during the motor rotation, thereby enhancing a sealing strength. As a result, it is possible to certainly prevent the oil from flowing from the capillary seal 32 even during the high-speed rotation of the spindle motor.

Additionally, with the configuration in which the capillary seal 32 is inclined with respect to the rotational center axis, the tapered clearance constituting the capillary seal 32 can be elongated even in the thin spindle motor in comparison with a configuration in which a capillary seal is disposed on the same line as a rotational center axis. Consequently, the capacity of the oil retained in the capillary seal 30 can be increased, so that the oil can flow through the clearance without any outflow even if the quantity of the oil flowing into the capillary seal 32 is increased during the motor rotation.

Moreover, since the annular member 30 is formed by press working, it is possible to reduce the cost of each of the parts per se and the fabrication cost of each of the parts. Additionally, since the columnar portion 30a of the annular member 30 is disposed inward of the connecting portion 30c in the radial direction, and further, is formed into the shape inclined with respect to the rotational center axis, it is possible to reduce the number of man-hours required for the press working process. In other words, the columnar portion 30a is formed such that a part of a flat plate is erected by drawing a plurality of times because it is possible to more reduce the number of drawing times, for example, in the case where the columnar portion 30a is erected in inclination with respect to the connecting portion 30c than the case where the columnar portion 30a is erected substantially perpendicularly to the connecting portion 30c.

As described above, the engaging portion 30b is formed at the portion facing to the flange 4c of the bearing housing 4 in the axial and radial directions. The engaging portion 30b includes a flat surface 30b1, which is brought into continuous contact with the columnar portion 30a and is substantially parallel to the lower end surface of the flange 4c in the radial direction, and an inner circumferential surface 30b2, which is brought into continuous contact with the flat surface 30b1 and is disposed outward of the flange 4c in the radial direction so as to extend in the axial direction. The oil is sequentially retained in a radial clearance defined between the flange 4c and the inner circumferential surface 30b2 of the engaging portion 30b and in an axial clearance defined between the lower surface of the flange 4c and the flat surface 30b1 of the engaging portion 30b, and further, the retained oil flows continuously to the oil retained in the capillary seal 32 and the thrust dynamic pressure bearing 24. The flat surface 30b1 of the engaging portion 30b is disposed downward of the flange 4c in the axial direction, so that the rotor 10 can be prevented from being withdrawn from the stationary unit such as the bearing housing 4 during the rotation of the rotor 10.

In this manner, not only the capillary seal 32 but also a mechanism for preventing any withdrawal of the rotor 10 are disposed outward of the upper and lower radial dynamic pressure bearings 20 and 22 in the radial direction, thereby more reducing the thickness of the motor. Even in the case where the thickness of the motor is further reduced, the axial clearances of the upper and lower radial dynamic pressure bearings 20 and 22 can be elongated. As a consequence, since the entire portion facing to the inner circumferential surface of the sleeve 6 at the outer peripheral surface of the shaft 4 can be utilized as the bearing, the bearing stiffness can be satisfactorily achieved, thereby rotating and holding the rotor 10 with more stability.

In addition, the mechanism for preventing any withdrawal of the rotor 10 is disposed in the region full of the oil. Consequently, even if, for example, a disturbance such as an external vibration or impact is exerted on the motor, the impact caused by the disturbance can be attenuated owing to damping characteristics of the oil, thereby suppressing damage due to a contact between the flat surface 30b1 and the flange 4c to the minimum. Moreover, even if particles such as abrasion powder should be produced due to the contact, the particles cannot be immediately spattered outside of the bearing.

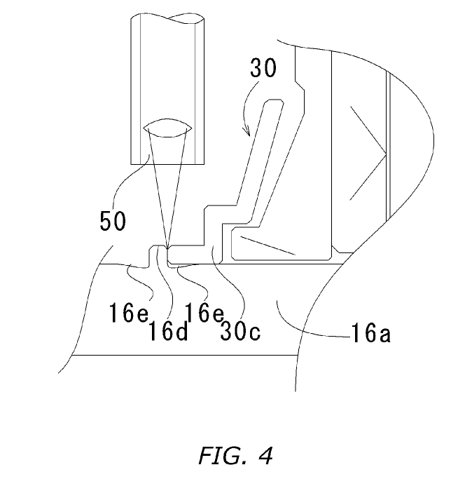

The connecting portion 30c extending outward of the engaging portion 30b in the radial direction is formed at the upper portion of the engaging portion 30b of the annular member 30 integrally with the engaging portion 30b. Here, explanation will be made below on a method for fixing the annular member 30 having the connecting portion 30c to the rotor hub 16 in reference to FIG. 4. FIG. 4 is a partly enlarged cross-sectional view showing a part of FIG. 1, in which the annular member 30 is fixed to the rotor hub 16.

First, the annular member 30 is fitted to the projection 16d projecting from the rotor upper wall 16a. At this time, the lower end surface of the connecting portion 30c (i.e., the upper end surface in FIG. 4) is disposed substantially flush with the lower end surface of the projection 16d (i.e., the upper end surface in FIG. 4) in the radial direction.

Next, a jig (not shown) is rotated in a state in which the rotor hub 16 is fixed to the jig. At a tightening portion 34 at which the outer peripheral surface of the connecting portion 30c and the inner circumferential surface of the projection 16d being contacted with each other is disposed an irradiation port 50 substantially on an extension in the axial direction of the tightening portion 34, for irradiating a laser as a directional energy beam, thereby welding the tightening portion 34 in a circumferential direction. This laser welding can secure a high tightening strength with a small quantity of heat in comparison with other welding such as arc welding or resistance welding, can facilitate handling without any need for a vacuum device, and can achieve local welding with an excellent directivity.

In this way, the high tightening strength between the members can be achieved in comparison with fixing means such as an adhesive by welding the annular member 30 to the projection 16d with the irradiation of the laser, thereby achieving firmer fixture.

In particular, even if the annular member 30 and the rotor hub 16 are constituted of members different in thermal expansion coefficient, the stable tightening strength can be obtained by using the laser welding as the fixing means, thereby achieving the firmer fixture.

The lower end surface of the connecting portion 30c is disposed flush with the lower end surface of the projection 16d in the radial direction, and further, the laser is irradiated on the extension in the axial direction of the tightening portion 34 defined between both of the members. Therefore, the annular member 30 is welded along the tightening portion 34 defined in the axial direction, thereby elongating the tightening length between both of the members by welding. As a consequence, the tightening strength between both of the members can be made much firmer, and further, the impact resistance can be enhanced.

Additionally, the oil can be prevented from being spattered from the tightening portion 34 by the laser welding in the circumferential direction. Moreover, recesses 16e and 16e caved upward in the axial direction from the lower end of the upper wall 16a are formed inward and outward of the projection 16d in the radial direction, respectively. The recesses 16e and 16e can prevent any generation of a stress when the annular member 30 is press-fitted to the projection 16d and any deviation of the rotor hub 16 caused by distortion due to the laser welding.

Incidentally, since the welding is associated with a great quantity of heat, gaseous argon as a cooling fluid serving as cooling means for cooling a welded portion is fed for cooling during the welding process. It is desirable that the cooling fluid should be made of a gaseous substance of a low reactivity with the metallic surface of the annular member 30 or the rotor hub 16. As the cooling fluid may be used helium or nitrogen of a high cooling efficiency. Although the laser welding has been performed while the rotor hub has been rotated in the present preferred embodiment, the fixing method is not limited to this. For example, the laser welding may be performed while the irradiation port is rotated in the circumferential direction.

Although the annular member 30 has been fitted to the projection 16d of the rotor hub 16 in the above-described fixing method, followed by fixing by the laser welding, the fixing method is not limited to this. For example, the annular member 30 may be fixed to the rotor hub 16 only by press-fitting as long as a predetermined tightening strength is obtained. Otherwise, an adhesive may be applied to the outer peripheral surface of the connecting portion 30c or the inner circumferential surface of the projection 16d, followed by press-fitting for fixture. Alternatively, the annular member 30 may be press-fitted to the projection 16d, followed by the laser welding.

Additionally, after the annular member 30 is press-fitted to the projection 16d, the tightening portion 34 defined between both of the members may be sealed with an adhesive over the entire circumference. Since the inner circumferential surface of the annular member 30 is the region full of the oil, the oil may possibly flow through the tightening portion 34 by a capillary phenomenon, to be spattered outside of the annular member 30. However, the fixing strength owing to the adhesive can be obtained by applying the adhesive over the entire circumference of the tightening portion 34, and further, the oil can be prevented from being spattered outside of the annular member 30.

Labyrinth Seal

A fourth fine clearance 17 is defined in the radial direction between the outer periphery of the columnar portion 30a and the lower end of the engaging portion 30b in the annular member 30 and the inner circumference and upper end of the cylindrical portion 2b of the bracket 2. The width of the fourth fine clearance 17 is gradually narrowed upward in the axial direction. In this manner, the fourth fine clearance 17 can function as a labyrinth seal during the motor rotation by setting the width of the fourth fine clearance 17 as narrow as possible. That is to say, a difference in flow rate between the oil and the air becomes large at the fourth fine clearance 17 during the motor rotation, and therefore, an outside outflow resistance of vapor generated by vaporization of the oil becomes large, thereby keeping a high vapor pressure of the oil in the vicinity of the interface, so as to prevent the oil from being further spattered.

The fourth fine clearance 17 can function as the labyrinth seal by partly setting the width of the fourth fine clearance 17 as narrow as possible: specifically, only a portion having a narrowest width at the fourth fine clearance 17 can function as the labyrinth seal. Therefore, the inner circumference of the cylindrical portion 2b of the bracket 2 can be formed into a shape substantially parallel to the rotational center axis.

Incidentally, a material of the annular member 30 is not particularly limited: for example, the annular member 30 may be formed of a material such as stainless steel, aluminum, an aluminum alloy, copper, a copper alloy or the like. In addition, the annular member 30 may be formed of a material having a thermal expansion coefficient higher than that of the bearing housing 4. For example, the annular member 30 may be formed of SUS 303 (having a thermal expansion coefficient of 17.3×10⁻⁶/° C.), SUS 304 (having a thermal expansion coefficient of 16.3×10⁻⁶/° C.) or the like: in contrast, the bearing housing 4 may be formed of SUS 420 (having a thermal expansion coefficient of 10.4×10⁻⁶/° C.) or the like.

When the spindle motor is rotated at a high speed, each of the dynamic pressure bearings also becomes high in temperature. In such a high temperature ambience, the oil is decreased in viscosity due to the thermal expansion, and further, the volume of the oil is increased. Therefore, the oil flows into the capillary seal 32 by the increased volume. If the capacity of the capillary seal 32 cannot be sufficiently secured, the oil is leaked outside of the motor, thereby degrading the reliability or durability of the motor. However, the thermal expansion coefficient of the annular member 30 is higher than that of the bearing housing 4 positioned inward of the annular member 30 in the radial direction, thereby increasing the width of the clearance in the radial direction of the capillary seal 32 defined between the inner circumferential surface of the annular member 30 and the outer peripheral surface of the bearing housing 4. As a consequence, the capacity of the oil, which can be retained in the capillary seal 32, can be increased in the high temperature ambience, and therefore, the oil by the increased volume can be sufficiently retained in the capillary seal 32.

Thus, it is possible to prevent the oil from flowing outside of the motor, so as to provide the spindle motor excellent in reliability and durability.

### Second Embodiment

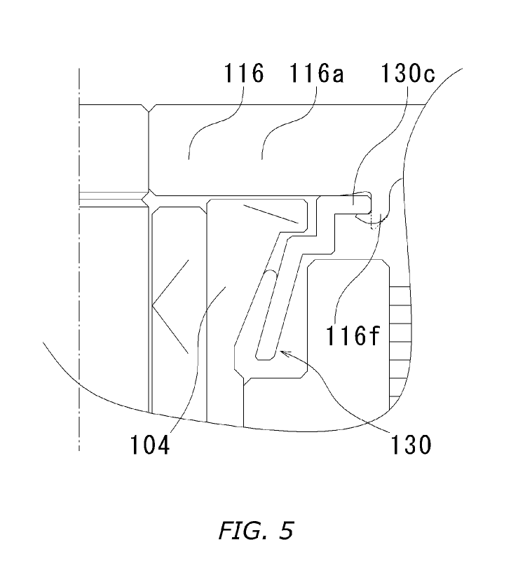

FIG. 5 is an enlarged cross-sectional view showing essential parts of a spindle motor in a second preferred embodiment according to the invention. The basic structure of the spindle motor in the second preferred embodiment is identical to that of the above-described first preferred embodiment, and therefore, corresponding component parts will be designated by reference numerals on the order of 100.

In FIG. 5, at a lower surface of a rotor upper wall 116a of a rotor hub 116 is formed a projection 116f disposed outward of a bearing housing 104 in a radial direction and projecting downward in an axial direction. To an inner circumference of the projection 116f is fixed an annular member 130 having a connecting portion 130c.

The annular member 130 is caulked and fixed by plastically deforming a tip of the projection 116f inward in the radial direction after the annular member 130 is fitted to the projection 116f of the rotor hub 116. The caulking may be performed at several portions in a circumferential direction or over the entire circumference. Thereafter, an adhesive may be applied to a tightening portion between the projection 116f and the connecting portion 130c in the circumferential direction. The tightening strength between the annular member 130 and the rotor hub 116 can become firmer with the application of the adhesive, and further, oil can be prevented from being spattered outside of the annular member 130.

### Third Embodiment

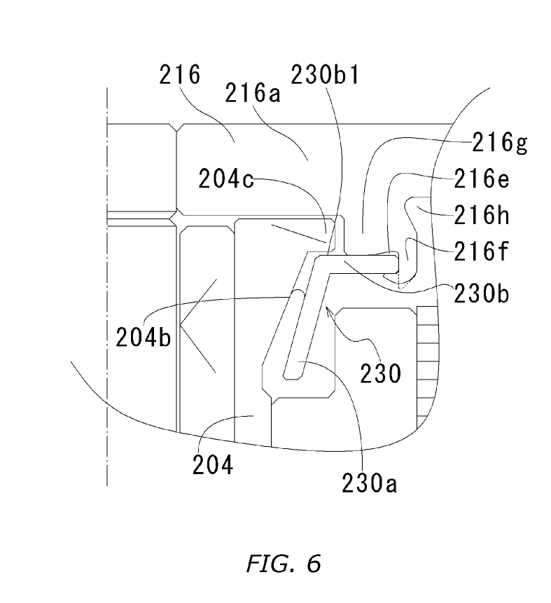

FIG. 6 is an enlarged cross-sectional view showing essential parts of a spindle motor in a third preferred embodiment according to the invention. The basic structure of the spindle motor in the third preferred embodiment is identical to that of the above-described first preferred embodiment, and therefore, corresponding component parts will be designated by reference numerals on the order of 200.

In FIG. 6, at a lower surface of a rotor upper wall 216a of a rotor hub 216 is formed a step 216g disposed outward of a bearing housing 204 in a radial direction and projecting downward in an axial direction. Furthermore, at a lower end of the step 216g is formed a projection 216f projecting downward in the axial direction. To an inner circumference of the projection 216f is fixed an annular member 230 having a engaging portion 230b and a columnar portion 230a.

The annular member 230 is caulked and fixed by plastically deforming a tip of the projection 216f inward in the radial direction after the annular member 230 is fitted inward of the projection 216f in the radial direction. At the lower end of the step 216g is formed a lower recess 216e. The lower recess 216e is adapted to absorb a stress generated during the plastic deformation of the projection 216f. Moreover, a peripheral recess 216h is formed also at the periphery of the step 216g. The peripheral recess 216h is designed to absorb the stress generated during the plastic deformation of the projection 216f, and further, to prevent the periphery of the rotor hub 216 from being deformed caused by the stress. The lower recess 216e and the peripheral recess 216h are formed at the same time when the step 216g and the projection 216f are formed during the molding of the rotor hub 216. Therefore, the lower recess 216e and the peripheral recess 216h can be formed with high accuracy at a reduced cost. Incidentally, the caulking may be performed at several portions in a circumferential direction or over the entire circumference.

Additionally, after the caulking, an adhesive may be applied to a tightening portion between the projection 216f and the engaging portion 230b in the circumferential direction. The tightening strength between the annular member 230 and the rotor hub 216 can become firmer with the application of the adhesive, and further, oil can be prevented from being spattered outside of the annular member 230. In addition, the annular member 230 may be fixed to the projection 216f with irradiation of a laser in the same manner as in the above-described first preferred embodiment.

The third preferred embodiment can produce the same functions and effects as those in the above-described first preferred embodiment, and further, the annular member 230 can be formed at a further reduced cost.

### Fourth Embodiment

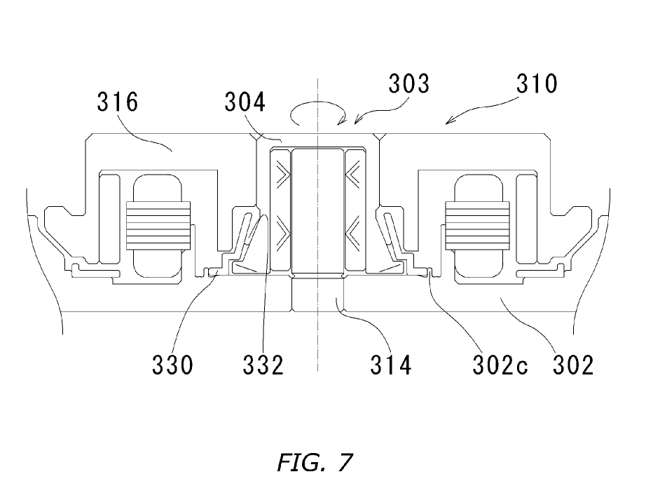

FIG. 7 is a cross-sectional view showing a spindle motor in a fourth preferred embodiment according to the invention. In the spindle motor in the fourth preferred embodiment, a shaft 314 is fixed at the center of a bracket 302. The shaft 314 is adapted to support therein a rotor 310 via fluid dynamic pressure bearings. The rotor 310 is provided with a bearing member 303 and a substantially cup-like rotor hub 316 secured at the periphery of the bearing member 303.

A projection 302c projecting upward in an axial direction is formed at a part of an upper surface of the bracket 302. At an inner circumference of the projection 302c is fixed a substantially conical annular member 330 formed by press working.

The width of a fine clearance defined between an inner circumferential surface of the annular member 330 and an outer peripheral surface of a bearing housing 304 is gradually enlarged from the upper surface of the bracket 302 toward a rotational center axis. That is to say, a capillary seal 332 is constituted in cooperation of the inner circumferential surface of the annular member 330 with the outer peripheral surface of the bearing housing 304. Oil retained in each of the dynamic pressure bearings is balanced in surface tension and outside atmosphere only at the capillary seal 332, so that an interface between the oil and air is formed into a meniscus shape.

The fourth preferred embodiment can produce the same functions and effects as those in the first preferred embodiment.

Recording Disk Drive Device

Next, a description will be given below of an inside configuration of a typical recording disk drive device 70 in reference to FIG. 8.

The recording disk drive device 70 includes a rectangular housing 71 having an upper housing member 72 and a lower housing member 73. Inside of the housing 71 is defined a clean space containing a remarkably small quantity of dust or the like. Inside of the space is housed a spindle motor 74 having the disk-like hard disk 76, on which information is recorded.

Furthermore, inside of the housing 71 is housed a head moving mechanism 84 for reading or writing the information from or on the hard disk 76. The head moving mechanism 84 is constituted of a magnetic head 82 for reading or writing the information written on the hard disk 76, an arm 80 for supporting the magnetic head 82, and an actuator 78 for moving the magnetic head 82 and the arm 80 to required positions on the hard disk 76.

The recording disk drive device can be reduced in size and thickness while securing satisfactory functions by using the spindle motor shown in FIGS. 1 to 7 as the spindle motor 74 for the above-described recording disk drive device 70. Thus, it is possible to provide the recording disk drive device excellent in reliability and durability.

Although the description has been given above of the fluid dynamic pressure bearing, the spindle motor provided with the fluid dynamic pressure bearing and the recording disk drive device provided with the spindle motor according to the invention, the invention is not limited to the above-described preferred embodiments, and therefore, the invention can be variously modified or altered without departing from the scope of the invention.

Although the bearing member has been constituted of the two members, that is, the bearing housing and the sleeve in each of the above-described preferred embodiments, the invention is not limited to this. For example, the bearing member may be constituted of a single member. In such a case, the radial dynamic pressure bearing is disposed at the inner circumferential surface of the bearing member, the thrust dynamic pressure bearing is disposed at the upper end surface, and the capillary seal is disposed at the periphery.

Otherwise, the bracket in each of the above-described preferred embodiments according to the invention may be formed integrally with the lower housing member 73 in the recording disk drive device.

Alternatively, the dynamic pressure generating groove formed at the thrust dynamic pressure bearing may be formed at the upper end of the sleeve.

What is claimed is:

1. A fluid dynamic pressure bearing comprising:
a rotor unit rotated coaxially with a rotational center axis and including a shaft, a rotor hub and an annular member; and
a stationary unit including a bearing member; wherein
the rotor hub has a rotor upper wall fixed to an upper end of the shaft;
the annular member is formed by press working and fixed to a lower surface of the rotor upper wall and extends downward in an axial direction;
the bearing member has an inner circumferential surface facing to an outer peripheral surface of the shaft via a first fine clearance, an upper end surface facing to the lower surface of the rotor upper wall via a second fine clearance, and an outer peripheral surface facing to an inner circumferential surface of the annular member via a third fine clearance;
the first, second and third fine clearances are filled with lubricating fluid substantially without interruption; and
the third fine clearance has a capillary seal whose radial clearance width is gradually enlarged downward in the axial direction, and further, the lubricating fluid retained in the third fine clearance defining an interface between air and the same inside of the capillary seal.

2. A fluid dynamic pressure bearing according to claim 1, wherein the inner circumferential surface of the annular member forming the capillary seal includes a portion at which a distance of the inner circumferential surface from the rotational center axis is gradually reduced downward in the axial direction from the rotor upper wall.

3. A fluid dynamic pressure bearing according to claim 1, wherein:
a flange, which is positioned upward of the capillary seal in the axial direction and extends outward of the capillary seal in the radial direction, is formed at the outer periphery of the bearing member; and
a engaging portion, which is contact with the flange when the rotor hub is moved in a direction separated from the bearing member, is formed at the annular member.

4. A fluid dynamic pressure bearing according to claim 1, wherein the stationary unit has a cylindrical portion facing to the outer peripheral surface of the annular member via a fourth fine clearance.

5. A fluid dynamic pressure bearing according to claim 4, wherein a radial clearance width of the fourth fine clearance is gradually reduced upward in the axial direction.

6. A fluid dynamic pressure bearing according to claim 1, wherein the annular member is made of a member having a thermal expansion coefficient higher than that of the bearing member.

7. A fluid dynamic pressure bearing according to claim 1, wherein a projection projecting downward of the rotor upper wall is formed outward of the annular member at the lower surface of the rotor upper wall in the radial direction.

8. A fluid dynamic pressure bearing according to claim 7, wherein the annular member is fixed to the rotor hub by plastically deforming the lower end of the projection inward in the radial direction.

9. A fluid dynamic pressure bearing according to claim 7, wherein the annular member is welded and fixed to the rotor hub by irradiating a directional energy beam.

10. A fluid dynamic pressure bearing according to claim 1, wherein:
a step extending downward from the rotor upper wall is formed outward of the annular member at the lower surface of the rotor upper wall in the radial direction; and
a projection projecting downward of the lower end of the step is formed at the lower end of the step.

11. A fluid dynamic pressure bearing according to claim 10, wherein the annular member is fixed to the rotor hub by plastically deforming the lower end of the projection inward in the radial direction.

12. A fluid dynamic pressure bearing according to claim 10, wherein the annular member is welded and fixed to the rotor hub by irradiating a directional energy beam.

13. A fluid dynamic pressure bearing according to claim 10, wherein the annular member is fixed to the rotor hub via an adhesive.

14. A fluid dynamic pressure bearing according to claim 10, wherein a recess is caved upward at a corner between the lower end of the step and an inner circumference of the projection in continuous contact with the lower end of the step.

15. A fluid dynamic pressure bearing according to claim 10, wherein a recess is caved inward in the radial direction in a region from the outer periphery of the step to the lower surface of the rotor hub in continuous contact with the outer periphery of the step.

16. A fluid dynamic pressure bearing according to claim 1, wherein:
a radial dynamic pressure bearing having a dynamic pressure generating groove for generating a fluid dynamic pressure with respect to the lubricating fluid during rotation of the rotor unit is disposed at the first fine clearance; and
a thrust dynamic pressure bearing having a dynamic pressure generating groove for generating a fluid dynamic pressure with respect to the lubricating fluid during the rotation of the rotor unit is disposed at the second fine clearance.

17. A fluid dynamic pressure bearing according to claim 1, wherein:
the bearing member is provided with a sleeve, which has the bearing hole and is made of a porous sintered material impregnated with the oil, and a bottomed cylindrical bearing housing, which is disposed at the outer periphery of the sleeve;
a radial dynamic pressure bearing having a dynamic pressure generating groove for generating a fluid dynamic pressure with respect to the lubricating fluid during rotation of the rotor unit is disposed at the first fine clearance defined between an inner circumferential surface of the sleeve and an outer peripheral surface of the shaft; and
a thrust dynamic pressure bearing having a dynamic pressure generating groove for generating a fluid dynamic pressure with respect to the lubricating fluid during the rotation of the rotor unit is disposed at the second fine clearance defined between an upper end surface of the sleeve and an upper end surface of the bearing housing, and the lower surface of the rotor upper wall.

18. A spindle motor comprising:
a stator held in a stationary unit;
a field magnet being held in a rotor unit and facing to the stator; and
the fluid dynamic pressure bearing according to claim 1.

19. A recording disk drive device according to claim 18 having a recording disk, on which information can be recorded, disposed therein, the recording disk drive device comprising:
the spindle motor according to claim 18, for rotating the recording disk;
an access unit for reading and/or writing the information from and/or on the recording disk; and
a housing member defining a housing containing, in an inside space thereof, the recording disk, the spindle motor and the access unit in addition to the stationary unit of the spindle motor, so as to partition them from an outside space.

20. A fluid dynamic pressure bearing comprising:
a rotor unit rotated coaxially with a rotational center axis and including a rotor hub and a bearing member; and
a stationary unit including a bracket, a shaft fixed to the center of the bracket and an annular member; wherein
the rotor hub has a rotor upper wall fixed to an upper end of the bearing member;
the annular member is formed by press working and fixed to an upper surface of the bracket and extends upward;
the bearing member has an inner circumferential surface facing to an outer peripheral surface of the shaft via a first fine clearance, a lower end surface facing to the upper surface of the bracket via a second fine clearance, and an outer peripheral surface facing to an inner circumferential surface of the annular member via a third fine clearance;
the first, second and third fine clearances are filled with lubricating fluid substantially without interruption; and
the third fine clearance has a capillary seal whose radial clearance width is gradually enlarged upward in an axial direction, and further, the lubricating fluid retained in the third fine clearance defining an interface between air and the same inside of the capillary seal.
